(19) United States
(12) Patent Application Publication
(10) Pub. No.: US 2015/0212961 A1
(43) Pub. Date: Jul. 30, 2015

(54) USB SERVER

(71) Applicant: IOI Technology Corporation, New Taipei City (TW)

(72) Inventor: Hua-Kang WU, New Taipei City (TW)

(21) Appl. No.: 14/474,190

(22) Filed: Sep. 1, 2014

(30) Foreign Application Priority Data
Jan. 29, 2014 (TW) 103202080

(51) Int. Cl. G06F 13/40; G06F 13/38

(52) U.S. Cl. CPC G06F 13/4022; G06F 13/385

(57) ABSTRACT

A USB server includes a casing, a motherboard, a PCIe switch host card, a USB to PCIe control card, and a connecting cable. The PCIe control card is inserted on the motherboard and includes a first PCIe bus connecting port. The USB to PCIe control card includes a second PCIe bus connecting port and a plurality of USB receptacle ports. The connecting cable is connected between the first PCIe bus connecting port and the second PCIe bus connecting port, and the USB receptacle ports are located on a front side of the casing.

### RELATED APPLICATIONS

This application claims priority to Taiwan Application Serial Number 103202080, filed Jan. 29, 2014, which is herein incorporated by reference.

### BACKGROUND

1. Field of Invention

The present invention relates to a sever, and more particularly, to a universal serial bus (USB) server with a large number of USB receptacle ports.

2. Description of Related Art

With the evolution of technology, devices equipped with USB technology is now commonplace. Examples of such devices include cell phones, tablet computers, external hard disk drives, flash drives, digital cameras, MP3 (Moving Picture Experts Group Layer-3 Audio) players, etc. Typically, transmitting data using the USB standard involves utilizing the USB receptacle ports of a computer. However, the computer only possesses a limited number of USB receptacle ports. If there are many USB devices, the computer may not have a sufficient number of USB receptacle ports.

### SUMMARY

According to an embodiment of the invention, a USB server is provided. The USB server includes a casing, a motherboard, a PCIe (Peripheral Component Interconnect Express) switch host card, at least one USB to PCIe control card, and at least one connecting cable. The motherboard is installed inside the casing and has a PCIe female slot. The PCIe switch host card includes a plurality of first PCIe bus connecting ports and a PCIe male connector, in which the PCIe male connector is inserted into the PCIe female slot of the motherboard. The USB to PCIe control card includes a second PCIe bus connecting port and a plurality of USB receptacle ports, in which the plurality of the USB receptacle ports are located on a front side of the casing. At least one connecting cable is connected between one of the first PCIe bus connecting ports and the second PCIe bus connecting port. The first PCIe bus connecting ports, the second PCIe bus connecting port and the at least one connecting cable transmit a signal using a PCIe X2 communication standard.

According to another embodiment of the invention, a USB server is provided. The USB server includes a casing, a motherboard, a USB host adapter, at least one USB hub, and at least one connecting cable. The motherboard is installed inside the casing and has a PCIe female slot. The USB host adapter includes a plurality of first USB 2-in-1 connecting ports and a PCIe male connector, in which the PCIe male connector is inserted into the PCIe female slot of the motherboard. At least one USB hub includes a second USB 2-in-1 connecting port and a plurality of USB receptacle ports, in which the plurality of the USB receptacle ports are located on a front side of the casing. At least one connecting cable is connected between one of the first USB 2-in-1 connecting ports and the second USB 2-in-1 connecting port. The first USB 2-in-1 connecting ports, the second USB 2-in-1 connecting port, and the at least one connecting cable transmit a signal using a USB communication standard.

According to one or more embodiments of the USB server of the present invention, a plurality of the USB receptacle ports are installed on a front side of the casing, so as to allow for the use of many USB devices. In addition, through the connection of the PCIe switch host card to the USB to PCIe control cards or through the connection of the USB host adapter to the USB hubs, each of the USB to PCIe control cards or each of the USB hubs has a fixed bandwidth shared with the downstream USB receptacle ports, so that the bandwidth of each USB receptacle port does not reduce when more USB receptacle ports are used. Accordingly, the USB server of the present invention allows for the use of a large number of USB devices with a high transmission speed, and good power delivery and power charging functions.

### BRIEF DESCRIPTION OF THE DRAWINGS

The invention can be more fully understood by reading the following detailed description of the embodiment, with reference made to the accompanying drawings as follows:

FIG. 1 illustrates a perspective view of a USB server in accordance with an embodiment of the present invention.

FIG. 2 illustrates a front view of a first PCIe bus connecting port of FIG. 1.

FIG. 3 through FIG. 5 illustrate various arrangements of USB receptacle ports of a USB server of the present invention.

FIG. 6 illustrates a perspective view of a USB server in accordance with another embodiment of the present invention.

FIG. 7 illustrates a front view of first USB 2-in-1 connecting ports of FIG. 6.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations. Wherever possible, the same reference numbers are used in the drawings and the description to refer to the same or like parts.

The following embodiments disclose a USB server with at least sixteen USB receptacle ports to which a large quantity of USB devices can be connected simultaneously. Furthermore, the USB server disclosed in the following embodiments can offer a relatively wide transmission bandwidth for downstream USB receptacle ports, so that each of the USB receptacle ports of the USB server can maintain a fixed data transfer speed. This is in contrast to the conventional USB hub, in which the data transfer speed of each USB receptacle port may slow down as the number of USB ports that are used increases.

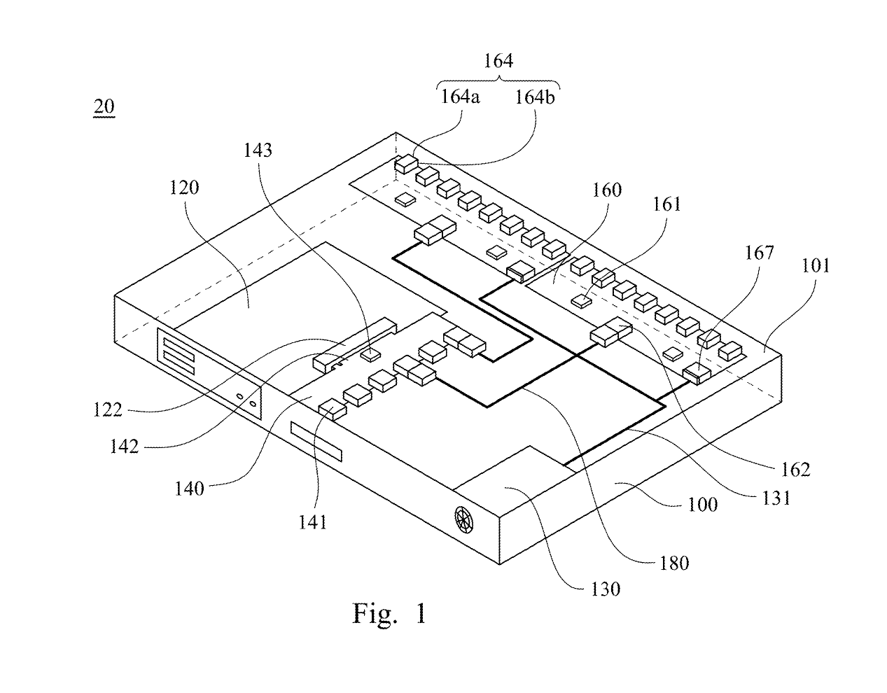

Reference is made first to FIG. 1 which illustrates a perspective view of a USB server in accordance with an embodiment of the present invention. In FIG. 1, the inner components inside a casing 100 of a USB server 20 are illustrated in order to dearly demonstrate the configuration of the invention, but in actual applications, the inner components inside the casing 100 are usually unseen. As shown in FIG. 1, the USB server 20 includes the casing 100, a motherboard 120, a power supply 130, a power cable 131, a PCIe switch host card 140, two USB to PCIe control cards 160 and two connecting cables 180. In the present embodiment, the size of the USB server 20 may be 1 U (1 rack unit), a unit of measure which was designated by the Electronic Industries Alliance (EIA). In other embodiments, the size of the USB server 20 may be greater than 1 U. Further, a motherboard 120 may be installed inside the casing 100 of the USB server 20. In the some embodiments, the motherboard 120 may be a Mini-ITX, ATX or EATX motherboard.

The PCIe switch host card 140 includes a plurality of first PCIe bus connecting ports 141, a PCIe packet switch chip 143 and one PCIe male connector 142. In the present embodiment, the first PCIe bus connecting ports 141 and the PCIe male connector 142 can transmit a signal using a PCIe communication standard, in which the PCIe male connector 142 is a male connector with an X16 standard. The PCIe male connector 142 can be inserted into the PCIe female slot 122 of the motherboard 120. A single PCIe signal can be converted into a plurality of signals through the PCIe packet switch chip 143 for transmitting to the plurality of the first PCIe bus connecting ports 141. The number of the first PCIe bus connecting ports 141 may be six and each of the first PCIe bus connecting ports 141 may be a 19 pin connector, but the present invention is not limited in this regard. In other embodiments, the PCIe male connector 142 can be a male connector with an X8 standard and the number of the first PCIe bus connecting ports 141 may be for.

Each of the USB to PCIe control cards 160 includes a second PCIe bus connecting port 162, a power input port 167, a plurality of USB to PCIe control chips 161 and a plurality of USB receptacle ports 164. The second PCIe bus connecting port 162 can transmit a signal using a PCIe X2 communication standard similar to the first PCIe bus connecting port 141. The connecting cable 180 can connect between one of the first PCIe bus connecting ports 141 and the second PCIe bus connecting port 162. The USB receptacle ports 164 are located on a front side 101 of the casing 100. In the present embodiment, each of the USB to PCIe control cards 160 may have two USB to PCIe control chips 161 and each USB to PCIe control chip 161 may control four USB receptacle ports; thus the number of the USB receptacle ports 164 of each USB to PCIe control card 160 is eight. In other embodiments, the number of the USB receptacle ports 164 controlled by one USB to PCIe control chip 161 may differ from the present embodiment according to actual requirements. In addition, in the present embodiment, each of the USB receptacle ports 164 may be a USB 3.0 receptacle port. In other embodiments, each of the USB receptacle ports 164 may be a USB 2.0 receptacle port or other recent version of USB receptacle port. In the present embodiment, the power supply 130 may deliver power to the power input port 167 through the power cable 131, so as to provide power to the USB to PCIe control card 160.

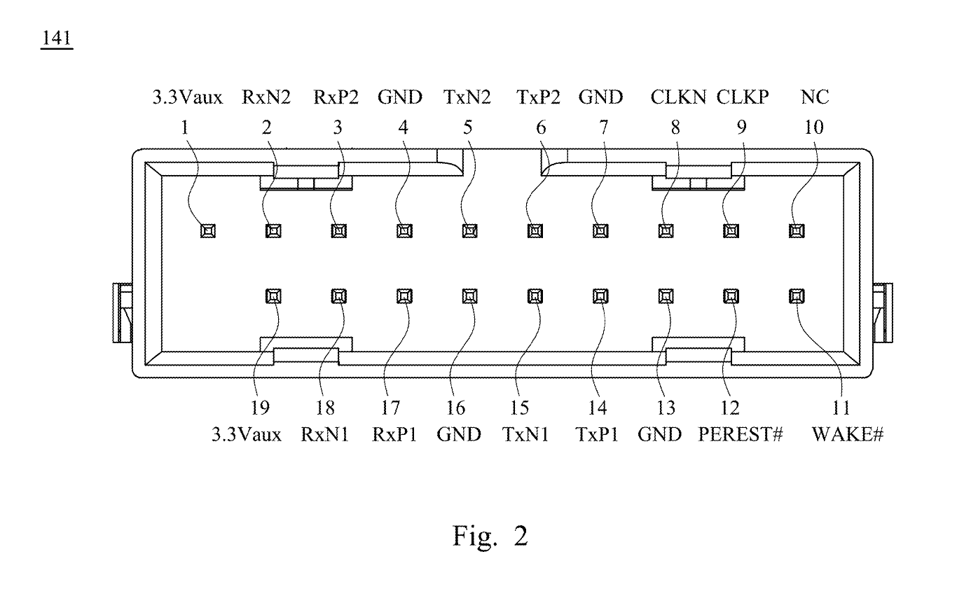

In the present embodiment, the first and second PCIe bus connecting ports 141, 162 may be a standard USB 3.0 2-in-1 19 pin connecting port, and the connecting cable 180 may be a standard USB 3.0 2-in-1 19 pin connecting line, in which the 19 pin connectors of the first and second PCIe bus connecting ports 141, 162 may be redefined to transmit a signal using the PCIe X2 standard. Reference is made to both the table below that lists each definition of 19 pins and FIG. 2, in which FIG. 2 illustrates a front view of a first PCIe bus connecting port

| Pin | Symbol |
|---|---|
| 1 | 3.3Vaux |
| 2 | RxN2 |
| 3 | RxP2 |
| 4 | GND |
| 5 | TxN2 |
| 6 | TxP2 |
| 7 | GND |
| 8 | CLKN |
| 9 | CLKP |
| 10 | NC |
| 11 | WAKE# |
| 12 | PERST# |
| 13 | GND |
| 14 | TxP1 |
| 15 | TxN1 |
| 16 | GND |
| 17 | RxP1 |
| 18 | RxN1 |
| 19 | 3.3Vaux |

In the present embodiment, a large number of the USB receptacle ports 164 are located on the front side 101 of the casing 100 of the USB server 20 through the expansion by the plurality of the USB to PCIe control cards 160. For example, in the embodiment of FIG. 1, there are two of the USB to PCIe control cards 160 and a total of sixteen of the USB receptacle ports 164, but the present invention is not limited in this regard. In other embodiments, the number of the USB receptacle ports 164 may be twenty-four, thirty-two, forty, or forty-eight.

It is noted that in the present embodiment, through the connecting configuration of the PCIe switch host card 140, the first PCIe bus connecting ports 141, the connecting cables 180, the second PCIe bus connecting port 162, and each of the USB to PCIe control cards 160 can have a relatively wide transmission bandwidth; thus, though the USB server 20 of the present embodiment has a large number of the USB receptacle ports 164, the transmission bandwidth of each USB receptacle port 164 is not reduced regardless of the number of the USB receptacle ports 164 that are utilized.

This is described in greater detail by taking a PCIe switch host card 140 with six first PCIe bus connecting ports 141 as an example. If one PCIe switch host card 140 has a bandwidth of 60 Gbps with a PCIe X16 standard, then in the present embodiment, each of the first PCIe bus connecting ports 141, the connecting cables 180 and the second PCIe bus connecting ports 162 can transmit with a bandwidth of at least 10 Gbps. Accordingly, one USB to PCIe control chip 161 of the USB to PCIe control card 160 can transmit 5 Gbps data which can be shared with four USB receptacle ports 164. As a result, if the USB receptacle ports 164 of the present embodiment are USB 3.0 receptacle ports, then each of the USB receptacle ports 164 has at least 1.25 Gbps bandwidth, and this bandwidth will not reduce when more and more USB receptacle ports 164 are used.

It is worth noting that each of the USB receptacle ports 164 of the present embodiment may comply with the BC (Battering Charging) or PD (Power Delivery) power transmission specification. Under the BC specification, the USB receptacle port 164 can transmit 5V of power and 10 W of electricity. Under the PD specification, the USB receptacle port 164 can transmit 100 W of electricity.

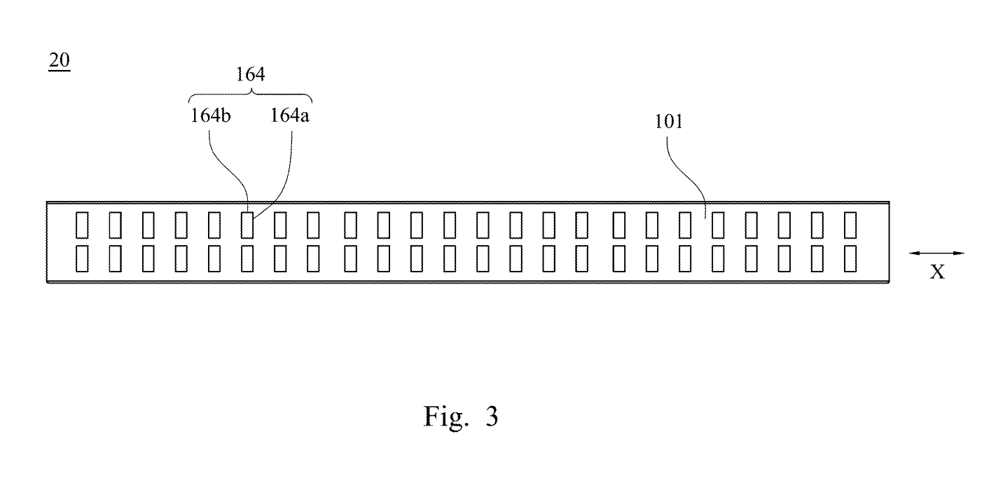

In some embodiments, the number of the USB to PCIe control cards 160 may be three to six and all the USB receptacle ports 164 can still be located on the same front side 101 of the casing 100, so that the space of the front side 101 can be fully used. For example, in FIG. 3, the number of the USB to PCIe control cards 160 is six, and thus the number of the USB receptacle ports 164 is forty-eight, in which the forty-eight USB receptacle ports 164 are arranged in two parallel rows along a direction X on the front side 101 of the casing 100, and each row has twenty-four USB receptacle ports 164. Each of the USB receptacle ports 164 has a pair of long sides 164a and a pair of short sides 164b and the long sides 164a of neighboring USB receptacle ports 164 oppose each other. That is, in FIG. 3, the USB receptacle ports 164 are set up vertically, so that the front side 101 of the casing 100 can accommodate all the USB receptacle ports 164.

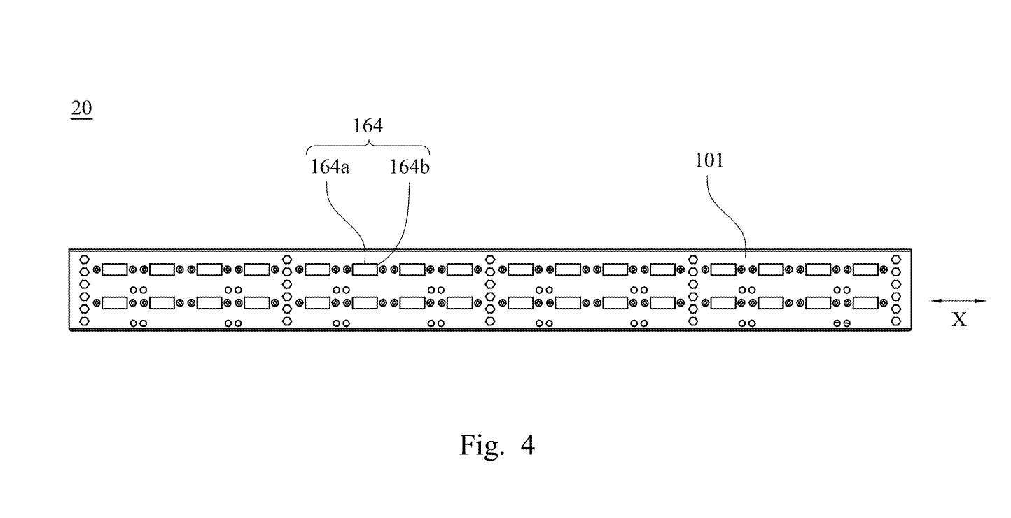

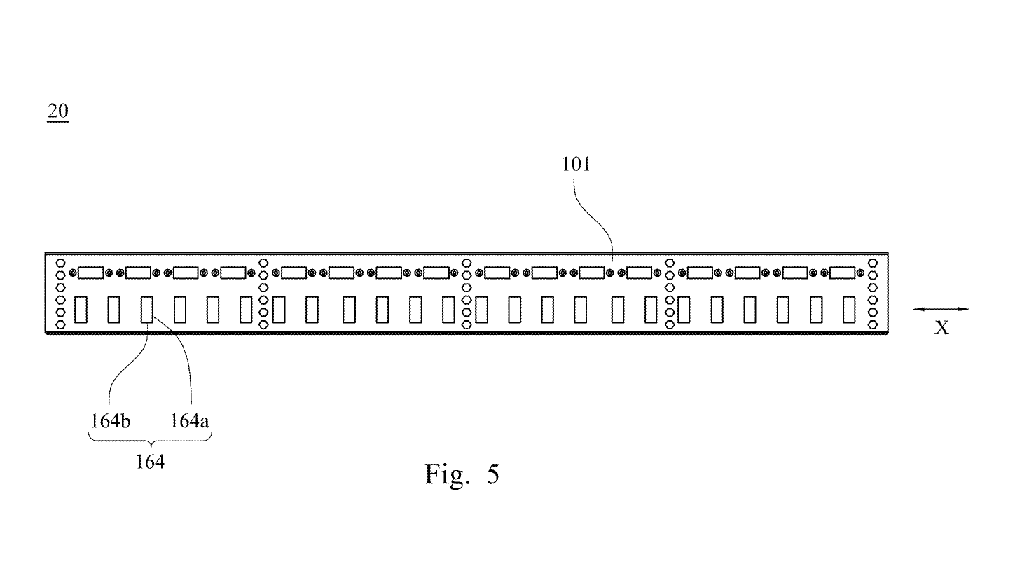

Reference is now made to FIG. 4. In some other embodiments, the number of the USB to PCIe control cards 160 is four, and thus the number of the USB receptacle ports 164 is thirty-two, in which the short sides 164b of neighboring USB receptacle ports 164 in each row oppose each other. That is, the USB receptacle ports 164 of the present embodiment are set up horizontally. In yet another embodiment, with reference to FIG. 5, the number of the USB to PCIe control cards 160 is five, and thus the number of the USB receptacle ports 164 is forty, in which the plurality of the USB receptacle ports 164 are arranged in two parallel rows on the front side 101 of the casing 100. The short sides 164b of the neighboring USB receptacle ports 164 in one row oppose each other, and such a row has 16 USB receptacle ports 164. The long sides 164a of neighboring USB receptacle ports 164 in the other row oppose each other and such a row has twenty-four USB receptacle ports 164.

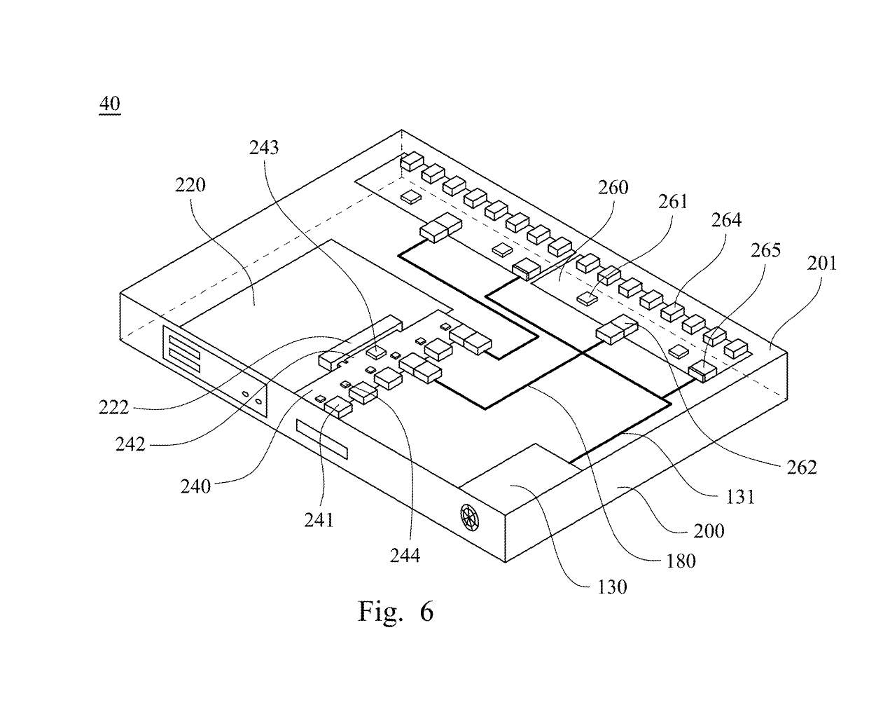

In the embodiment of FIG. 1, the PCIe switch host card 140 transmits signals using the PCIe communication standard through the first PCIe bus connecting ports 141, but the present invention is not limited in this regard. In the following embodiments, another USB server 40 is provided, and reference is made to FIG. 6 which illustrates a perspective view of the USB server 40. The difference between the USB server 40 of the present embodiment and the USB server 20 of the embodiment of FIG. 1 is that the USB server 40 of the present embodiment includes a USB host adapter 240 and a USB hub 260. The PCIe signal transmitting from the motherboard 220 to the USB host adapter 240 is converted into a signal using a USB communication standard by the USB host adapter 240.

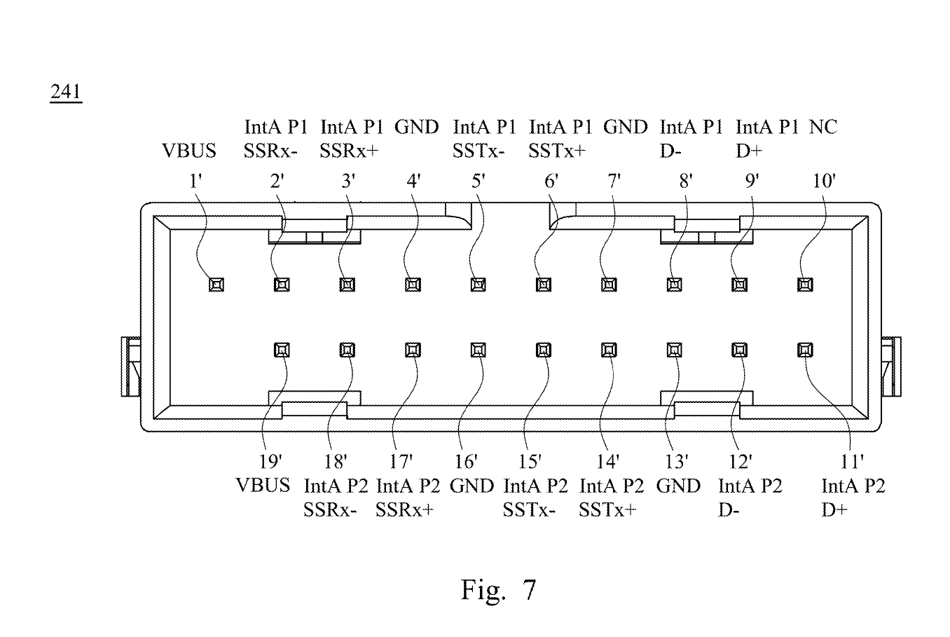

In more detail, the USB host adapter 240 includes a plurality of first USB 2-in-1 connecting ports 241, a PCIe male connector 242, a PCIe packet switch chip 243, and a plurality of USB to PCIe control chips 244. In the present embodiment, the PCIe male connector 242 can be a PCIe X16 male connector, and the PCIe male connector 242 can be inserted into the PCIe female slot 222 on the motherboard 220. The PCIe packet switch chip 243 of the USB host adapter 240 is used to convert a PCIe signal into a USB signal, and the USB to PCIe control chip 244 can control each of the first. USB 2-in-1 connecting ports 241. In the present embodiment, the number of the first USB 2-in-1 connecting ports 241 may be six. Further, the USB hub 260 includes a USB hub chip 261, a second PCIe bus connecting port 262, a plurality of USB receptacle ports 264 and a power input port 265. Each USB hub chip 261 can control four USB receptacle ports 264, and thus in FIG. 6, the number of the USB receptacle ports 264 is eight. The first USB 2-in-1 connecting ports 241 and the second USB 2-in-1 connecting ports 262 can be USB 3.0 2-in-1 19 pin connecting ports which can be used to transmit USB 3.0 standard signals. Further, the 19 pin connectors of the first USB 2-in-1 connecting ports 241 and the second USB 2-in-1 connecting ports 262 can be redefined to transmit signals using a USB 3.0 communication standard. Reference is made to both the table below that lists each definition of 19 pins and FIG. 7, in which FIG. 7 illustrates a front view of a first USB 2-in-1 connecting port 241.

| Pin | Symbol |
|---|---|
| 1′ | VBUS |
| 2′ | IntA P1 SSRX− |
| 3′ | IntA P1 SSRX+ |
| 4′ | GND |
| 5′ | IntA P1 D− |
| 6′ | IntA P1 D+ |
| 7′ | GND |
| 8′ | IntA P1 D− |
| 9′ | IntA P1 D+ |
| 10′ | NC |
| 11′ | IntA P2 D+ |
| 12′ | IntA P2 D− |
| 13′ | GND |
| 14′ | IntA P2 SSTX+ |
| 15′ | IntA P2 SSTX− |
| 16′ | GND |
| 17′ | IntA P2 SSTX+ |
| 18′ | IntA P2 SSTX− |
| 19′ | VBUS |

Referring to FIG. 6, the number of the USB hubs 260 of the present embodiment may be two, and thus the number of the USB receptacle ports may be sixteen. In other embodiments, the number of the USB hubs may be three to six, so the number of the USB receptacle ports may be twenty-four to forty-eight. It is noted that the total bandwidth of the USB hubs 260 of the present embodiment is shared by at most eight USB receptacle ports 264, so no matter how many of the USB receptacle ports 264 are utilized, the transmission speed of each USB receptacle port 264 will not be reduced.

In addition, in various embodiments, the USB receptacle ports 264 may be arranged in a horizontal configuration, vertical configuration or combination of horizontal and vertical configurations, so as to fully use the space of the front side 201 of the casing 200. Reference may be made to FIGS. 2 to 5 for the possible different arrangement configurations of the USB receptacle ports 264 of the present embodiment. In some embodiments, the USB receptacle ports 264 are not limited to being arranged on the front side 201, and can be arranged on different faces of the casing 200.

As discussed above, the USB server disclosed by the above embodiments has a large number of the USB receptacle ports, so as to allow for the connection of a large number of the USB devices. Further, by offering a relatively wide bandwidth by the PCIe bus, the downstream USB receptacle ports of the USB server can maintain fixed data transfer speeds.

What is claimed is:

1. A universal serial bus (USB) server, comprising:
a casing;
a motherboard installed inside the casing and having a PCIe female slot;
a PCIe switch host card comprising a plurality of first PCIe bus connecting ports and a PCIe male connector, wherein the PCIe male connector is inserted into the PCIe female slot of the motherboard;
at least one USB to PCIe control card comprising a second PCIe bus connecting port and a plurality of USB receptacle ports, wherein the plurality of the USB receptacle ports are located on a front side of the casing; and
at least one connecting cable connected between one of the plurality of the first PCIe bus connecting ports and the second PCIe bus connecting port, wherein the plurality of the first PCIe bus connecting ports, the second PCIe bus connecting port and the at least one connecting cable transmit a signal using a PCIe X2 communication standard.

2. The USB server of claim 1, wherein the PCIe male connector is a male connector with a X8 or X16 standard, the number of the first PCIe bus connecting ports is at least four and the number of the USB receptacle ports is at least four.

3. The USB server of claim 2, wherein each of the plurality of the USB receptacle ports has a pair of long sides and a pair of short sides, the plurality of the USB receptacle ports are arranged in two parallel rows on the front side of the casing, each row has at least two USB receptacle ports and the short sides of neighboring USB receptacle ports in each row oppose each other.

4. The USB server of claim 2, wherein each of the plurality of the USB receptacle ports has a pair of long sides and a pair of short sides, the plurality of the USB receptacle ports are arranged in two parallel rows on the front side of the casing, each row has at least two USB receptacle ports and the long sides of neighboring USB receptacle ports in each row oppose each other.

5. The USB server of claim 2, wherein each of the plurality of the USB receptacle ports has a pair of long sides and a pair of short sides, the plurality of the USB receptacle ports are arranged in two parallel rows on the front side of the casing, each row has at least two USB receptacle ports, the short sides of neighboring USB receptacle ports in one row oppose each other and the long sides of neighboring USB receptacle ports in the other row oppose each other.

6. The USB server of claim 1, wherein each of the first PCIe bus connecting ports and the second PCIe bus connecting port is a standard USB 3.0 2-in-1 19 pin connecting port.

7. A USB server, comprising:
a casing,
a motherboard installed inside the casing and having a PCIe female slot;
a USB host adapter comprising a plurality of first USB 2-in-1 connecting ports and a PCIe male connector, wherein the PCIe male connector is inserted into the PCIe female slot of the motherboard;
at least one USB hub comprising a second USB 2-in-1 connecting port and a plurality of USB receptacle ports, wherein the plurality of the USB receptacle ports are located on a front side of the casing; and
at least one connecting cable connected between one of the plurality of the first USB 2-in-1 connecting ports and the second USB 2-in-1 connecting port, wherein the plurality of the first USB 2-in-1 connecting ports, the second USB 2-in-1 connecting port, and the at least one connecting cable transmit a signal using a USB communication standard.

8. The USB server of claim 7, wherein the PCIe male connector is a male connector with a X8 or X16 standard, the number of the first USB 2-in-1 connecting ports is at least four and the number of the USB receptacle ports of the USB hub is at least four.

9. The USB server of claim 8, wherein each of the plurality of the USB receptacle ports has a pair of long sides and a pair of short sides, the plurality of the USB receptacle ports are arranged in two parallel rows on the front side of the casing, each row has at least two USB receptacle ports and the short sides of neighboring USB receptacle ports in each row oppose each other.

10. The USB server of claim 8, wherein each of the plurality of the USB receptacle ports has a pair of long sides and a pair of short sides, the plurality of the USB receptacle ports are arranged in two parallel rows on the front side of the casing, each row has at least two USB receptacle ports, the short sides of neighboring USB receptacle ports in one row oppose each other and the long sides of neighboring USB receptacle ports in the other row oppose each other.

11. The USB server of claim 8, wherein each of the first USB 2-in-1 connecting ports and the second USB 2-in-1 connecting port is a standard USB 3.0 2-in-1 19 pin connecting port.
